(19) United States
(12) Patent Application Publication
(10) Pub. No.: US 2006/0212158 A1
(43) Pub. Date: Sep. 21, 2006

(54) System for manufacturing an implant

(76) Inventor: Robert Miller, Del Rey Beach, FL (US)

Correspondence Address: GREENBERG TRAURIG LLP, 2450 COLORADO AVENUE, SUITE 400E, SANTA MONICA, CA, 90404, US

(21) Appl. No.: 11/313,878

(22) Filed: Dec. 20, 2005

Related U.S. Application Data
(60) Provisional application No. 60/639,239, filed on Dec. 23, 2004.

(51) Int. Cl. G06F 19/00

(52) U.S. Cl. 700/163; 623/901

(57) ABSTRACT

A system for manufacturing an implant using a combination of a scanning device for determining a three-dimensional representation of a shape and for digitizing parameters of the shape to define the shape, a software program for translating digitized parameters into instructions for operating a manufacturing machine, and a manufacturing machine that creates the implant from an undefined segment of material. Furthermore, the implant is formed essentially to fit with the volume of the shape.

### RELATED APPLICATION

This application claims the benefit of and priority to U.S. Provisional Application Ser. No. 60/639,239, filed Dec. 23, 2004, the contents of which are incorporated by reference herein in its entirety.

### BACKGROUND

1. Field

This application is related to the design, system, and manufacture of an implant or prosthesis for reconstructing, reducing, or augmenting the bone structure in a subject. In particular, the present disclosure relates to a combination of a scanning device for determining a three-dimensional representation of a shape and for digitizing parameters of the shape to define the shape, a software program for translating digitized parameters into instructions for operating a manufacturing machine, and a manufacturing machine that creates the implant from an undefined segment of material.

2. General Background

Modern oral implantology has gone through changes of architectures, surface characteristics and prosthetic manipulation. However, the technology still faces many constraints. A chief limitation to implant technology is that it currently lacks the ability to produce an implant with adequate bone volume and bone architecture to the hold the implant in the body.

Over the years, various modalities to increase bone volume have been developed. For example, particulate bone grafting, is available in autogenous, allogeneic, bovine, and alloplastic forms. While these materials are easily manipulated, achieving desirable bone architecture is difficult.

Another method is the use of autogenous bone block in grafting. This method entails cutting a bone segment from a donor area and transplanting it to the deficient area using bone screws. While this method often achieves greater bone volume, it rarely creates preferred bone contours. Either particulate bone needs to be used to fill in defects on the margins, or excess bone must be removed to fit the block and round off sharp contours before the tissue can be closed. Additional problems associated with this technique include a secondary surgical site, with increased morbidity and surgical complications such as altered sensation and infection. Surgical time is also significantly increased when block grafting is employed.

Another previous method involved making a computer-generated model of the bone, followed by creating a handmade-wax model of the bone. Meaning the technician or doctor would have to put wax onto the particular bone to replicate the contours of the bone he or she wanted. Then the wax part is digitized so that a computer could mill out a piece of hydroxyl appetite. However, this method is imprecise, time-consuming, and requires specialized manual craftsmanship.

U.S. Pat. No. 6,808,659 by Schulman et al. discloses a fabrication method for producing dental restorations using a CAD/CAM milling machine. However, the CAD/CAM machine requires at least two digital inputs, one of which involves referencing a library of teeth and forms to determine the proper shape and form of the implant. The subject matter of U.S. Pat. No. 6,808,659 is herein incorporated by reference in its entirety.

Furthermore, methods using scanning techniques, such as CT scans, utilize a very narrow fan beam that rotates around a patient, acquiring one image with each revolution. However, to image a section of anatomy many rotations must be completed, which means higher radiation exposure to the patient.

A more recent scanning technology for the maxillofacial region is digital volumetric tomography (DVT). This technology is found in machines such as the NewTom 3G or NewTom 9000. This technology uses focused cone beam technology to produce 3-dimensional images of the maxillofacial region. This DVT technology has a lower radiation dosage and scan time when compared to CT scanning. Although the field of dentistry has used the DVT technology for scanning purposes, it has not been used in conjunction with software and a manufacturing machine for the purpose of producing an implant.

Additionally, many techniques aimed at making an implant for replacing or augmenting bone structure do not use donor or cadaver bone. Donor or cadaver bone is advantageous because it eliminates the surgical and invasive step of harvesting bone from the patient.

Thus, it is desirable to provide a system for making implants that uses less radiation, is less surgically invasive, is more efficient, and produces an implant with accurate bone volume, contours, and architecture.

### SUMMARY

The present disclosure provides a system for manufacturing an implant having a preferred shape, architecture, and volume, through combining a three-dimensional scanning device, a software program, and a manufacturing machine. The scanning device scans the appropriate region of the subject to provide a three-dimensional representation of a shape. Then, the scanning device digitizes parameters of the shape or region scanned in conjunction with a software program. Once the preferred or desired shape is finalized, the software is exported to a manufacturing machine. Next, the software program instructs the manufacturing machine to use the digitized parameters of the shape to create an implant from an undefined segment of material.

In one embodiment, the scanning device uses digital volumetric tomography. In a further embodiment, the manufacturing machine is a CAD/CAM milling machine. Through a software program's instructions, the CAD/CAM milling machine uses the digitized parameters of the shape to create an implant from an undefined segment of material.

In a further embodiment, the undefined segment of material used to create the implant is donor bone material or cadaver bone material.

In one embodiment, the present disclosure provides a system for manufacturing an implant, comprising a scanning device for determining a three-dimensional representation of a shape having a volume, said scanning device capable of digitizing parameters of said shape to define said shape; and a software program for translating digitizing parameters into instructions for operating a manufacturing machine, through which said manufacturing machine creates said implant from an undefined segment of material. In one embodiment, the implant is formed so that it is essentially consonant with the volume of said shape and wherein said implant is suitable for implantation. In one embodiment, the implant is used for maxillofacial or dental reconstruction, maxillofacial or dental augmentation, maxillofacial or dental reduction of a body structure, and/or a prosthesis for repairing or restoring at least a portion of at least one bone of a vertebrate.

In one embodiment, the present disclosure provides a system for manufacturing an implant, comprising a scanning device for determining a three-dimensional representation of a shape having a volume, wherein said scanning device uses digital volumetric tomography technology and said scanning device capable of digitizing parameters of said shape to define said shape; and a software program for translating digitizing parameters into instructions for operating CAD/CAM milling machine through which said CAD/CAM milling machine creates said implant from an undefined segment of material.

In one embodiment, the present disclosure provides for an implant formed by scanning a subject with a scanning device in order to determine a three-dimensional representation of a shape and for digitizing parameters of the shape to define the shape; interfacing the scanning device with a software program for translating digitizing parameters into instructions; interfacing the software program and a manufacturing machine for instructing the machine; and machining from an undefined segment of material an implant that is formed to be essentially consonant with the volume of the shape.

In one embodiment, the present disclosure provides for an implant formed scanning a subject with a scanning device using digital volumetric tomography in order to determine a three-dimensional representation of a shape and for digitizing parameters of the shape to define the shape; interfacing the scanning device with a software program for translating digitizing parameters into instructions; interfacing the software program and a CAD/CAM milling machine for instructing the CAD/CAM milling machine; and machining from an undefined segment of cadaver bone an implant that is formed to be essentially consonant with the volume of the shape.

In one embodiment, the scanning device uses digital volumetric tomography. In another embodiment, the scanning device uses focused cone beam technology.

In one embodiment, the manufacturing machine is a CAD/CAM milling machine. In a further embodiment, the manufacturing machine creates the shape through a molding process.

In one embodiment, the material is bone from a donor or cadaver. In a further embodiment, the bone is selected from the group consisting of human, bovine, porcine, canine, feline or equine. In one embodiment, the vertebrate is alive or deceased. In one embodiment, the material is a material selected from the group consisting of plastic, polyethylene, hydroxyapatite, and synthetic bone compositions. In another embodiment, the material is a material selected from the group consisting of a material with bone stimulating growth hormone, a material with growth factor, and a material that acts as a scaffolding and promotes bone growth within the material where the scaffolding will eventually break down and safely dissolve leaving the newly formed bone to continued to strengthen and become a full, natural replacement.

Additionally, the present disclosure provides for various combinations and sub combinations of the embodiments. For example, in one embodiment, the scanning device uses digital volumetric tomography technology and scans the appropriate region of the subject to provide a three-dimensional representation of a shape. Then, the scanning device digitizes parameters of the shape or region scanned in conjunction with a software program. Once the preferred or desired shape is finalized, the software is exported to a CAD/CAM milling machine. Next, the software program instructs the CAD/CAM milling machine to use the digitized parameters of the shape to create an implant from an undefined segment of donor or cadaver bone.

### DRAWINGS

The above-mentioned features and objects of the present disclosure will become more apparent with reference to the following description taken in conjunction with the accompanying drawings wherein like reference numerals denote like elements and in which:

FIG. 1 is a diagram illustrating one embodiment of the disclosure.

FIG. 2 is a diagram illustrating another embodiment of the disclosure.

FIG. 3 is an illustration of focused cone beam technology.

### DETAILED DESCRIPTION

The device is now described with reference to an example that is not to be considered as limiting. This is purely an illustration of the device.

The present disclosure provides a system for manufacturing an implant using a combination of a scanning device for determining a three-dimensional representation of a shape and for digitizing parameters of the shape to define the shape, a software program for translating digitized parameters into instructions for operating a manufacturing machine, and a manufacturing machine, which creates the implant from an undefined segment of material.

Furthermore, the implant is formed to be essentially consonant with the volume of the shape. An implant may be considered essentially consonant with the volume of the shape when the implant is as close to and the exact desired size as possible or as close to the exact appropriate size as possible. It is recognized that the desired or appropriate implant will depend on the intended use of the implant. Thus, the present disclosure provides that the implant is formed to be as close as possible to the 3-dimensional shape determined by the scanning device and software program. Additionally, the implant is formed so that it is suitable for implantation.

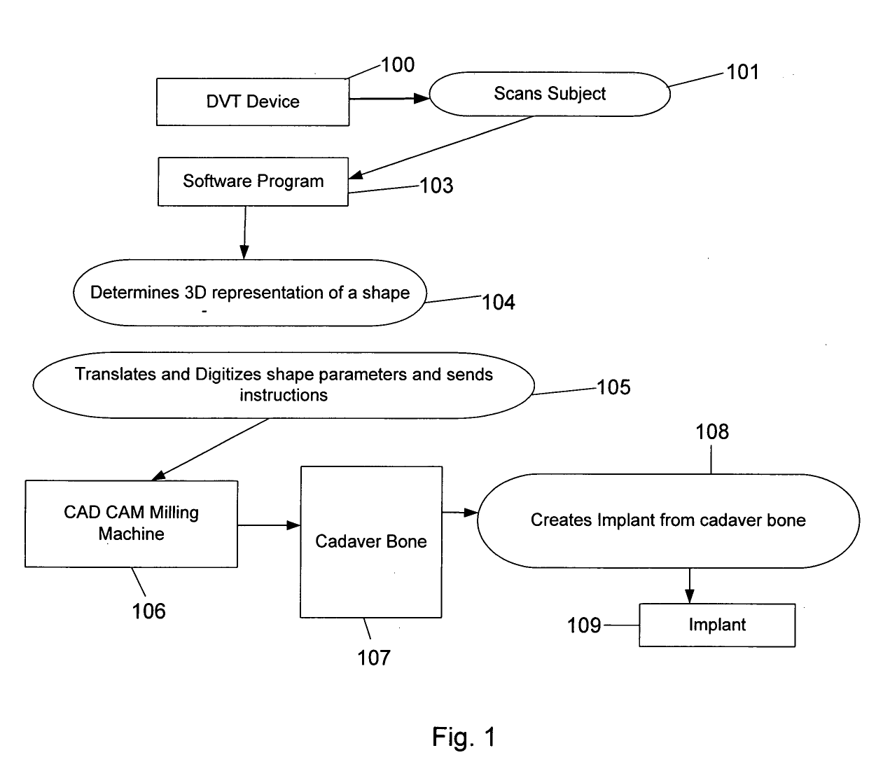

One embodiment of the present disclosure is depicted in FIG. 1. The scanning device 100 scans the appropriate region of the subject 101 to provide a three-dimensional representation of a shape 104. The three-dimensional image and representation can be constructed through various methods, such as segmentation or volumetric representation. Then, the scanning device 100, in conjunction with a software program 103, digitizes parameters of the shape 105 or region scanned. Once the preferred or desired shape is finalized, the software is exported to a manufacturing machine 106. Next, the software program instructs the manufacturing machine to use the digitized parameters of the shape 105 to create an implant 109 from an undefined segment of material 107. Furthermore, the implant is formed to be essentially consonant with the volume of the shape and suitable for implantation.

The implant can have many forms and several uses. The implant created by the disclosed system can be used for reconstruction, augmentation, reduction of a body structure or for any procedure that requires altering the bone structure of a vertebrate. Such vertebrates include, but are not limited to, human, bovine, porcine, canine, feline or equine. In one embodiment, the implant created is used for dental and maxillofacial purposes. In another embodiment, the implant may be used as a general prosthesis for repairing or restoring at least a portion of at least one bone of the subject. Also, the implant produced by the present disclosure has applications in different fields such as general dentistry, specialized dentistry such as orthodontics, endodontics, oral and maxillofacial surgery, periodontics, prosthodontics, orthopedics, plastic or reconstructive surgery, veterinary medicine, general prosthetics, and any other field that utilizes implants.

The implant can be made from many different materials. In one embodiment, the implant is made from a synthetic bone material or a hybrid bone material. In yet another embodiment, the implant is made from a material that contains elements to stimulate bone growth. Another embodiment, the implant is made from donor or cadaver bone. In yet another embodiment, the implant is made from a donor bone where the donor is either alive or deceased. Other materials contemplated by the present disclosure include but are not limited to, polyethylene, various plastics, synthetic or mineral hydroxyapatite, polymer and ceramic mixtures, metallic and ceramic compounds, bovine, porcine, harvested bone from the patient, materials that act as a scaffolding and promote bone growth, in which the scaffolding will eventually safely break down and dissolve leaving the newly formed bone to continue to strengthen and become a full and natural replacement, and any combinations thereof.

Additionally, the implant may be manufactured to include specialized features. Specialized features include, but are not limited to, creating the implant with specific holes for mating with bone screws. The holes can be threaded or smooth. Also, the implant can be treated with various growth factors to encourage bone growth. Also, the implant can include a reference or identifying number or marking system within or on the implant itself. Moreover, any manufactured implant will undergo the necessary sterilization process and packaging.

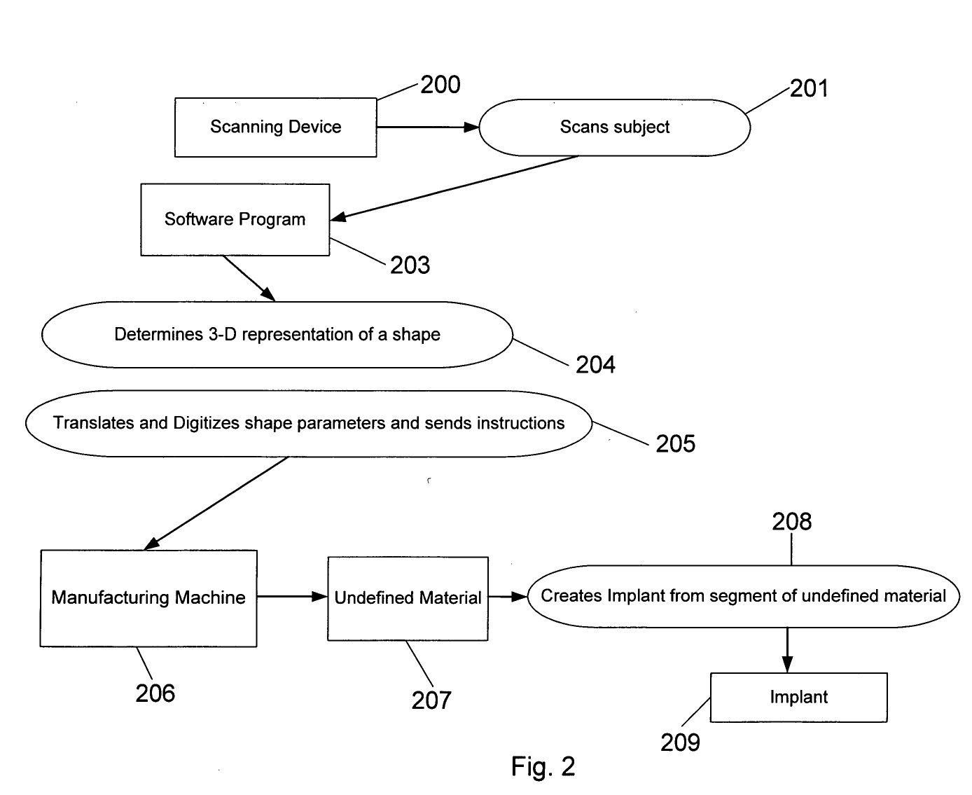

Another embodiment of the present disclosure is depicted in FIG. 2.

The embodiment depicted in FIG. 2 constructs an implant 209 using a digital volumetric (DVT) scanning device 200. The DVT scanning device scans the appropriate region of the subject 201 to provide a three-dimensional representation of a shape 204. The DVT scanning device 200 and software program digitizes the parameters of the shape to define the shape. DVT technology is capable of taking full volumetric scans of the oral and maxillofacial regions. Additionally, the present disclosure contemplates using DVT technology to scan various other parts of the subject's body.

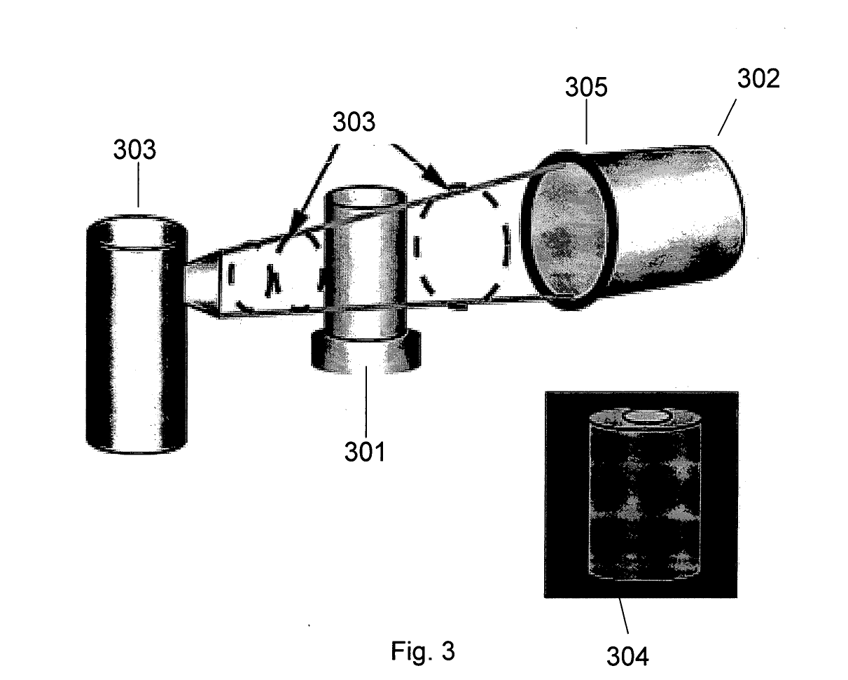

DVT-type scans use a focused cone beam technology or cone beam computed tomography. FIG. 3 depicts the focused cone beam technology 300. The subject to be scanned 301 is positioned between the image intensifier 302 and the x-ray source 303. The focused cone beam x-ray passes between the image intensifier 302, through the subject 301, and the x-ray source to take image data from all angles. Thus, the focused beam technology 300 is capable of collecting essentially the entire volume 304 of the scanned area in a few revolutions or ideally a single revolution around the subject 301.

Unlike DVT scans, CT scans use a narrower fan beam that rotates around the subject and only acquires one thin image with each revolution. Thus, CT scans require multiple revolutions to capture a full three-dimensional image.

Using DVT scanning and focused cone beam technology provides many benefits to the imaging and 3-dimensional modeling procedure disclosed. First, because DVT scans only require only revolution to capture the data, DVT scans use less radiation. Second, the time it takes to scan the patient is lowered. Another benefit of using digital volumetric technology is that there is virtually no distortion when digitized. Additionally, DVT scanning determines a more accurate volume. An accurate volume is important in the field of implants where bone volume is necessary to the fit and durability of the implant. Furthermore, the density and exact contour of the implant are subject-specific. Bone implants require specific bone volume and density in order to replicate the body structure's own natural stress and loading mechanisms to keep the bone healthy.

Although one embodiment uses digital volumetric tomography technology for scanning, the present disclosure provides for numerous other types of scanning devices when appropriate. For example, one embodiment entails scanning impressions of a patient's body region directly. Another embodiment uses CT scanning. Furthermore, any scanning technology which can efficiently determine a 3-dimensional representation of a patients' body region is contemplated. Of course, the choice of scanning device or scanning technology will depend on the resources, circumstances, and particular intended use of the implant of the disclosed system.

After the subject is scanned, the scanning device 200, in conjunction with a software program 203, digitizes parameters of the shape 205 or region scanned. The present disclosure provides for the use of a conversion software program, which could facilitate converting the digitized parameters from the scanning device into a manageable instruction set for the anatomical modeling program such as a CAD program. The present disclosure also provides for the use of a conversion software program, which could facilitate converting the digitized parameters from the scanning device into a manageable instruction set for the manufacturing machine.

The desired shape of the implant will depend on its intended use. For example, if the implant is used to replace missing bone, the software program and scanning device will construct the appropriate three-dimensional image of the implant. This can be done through the software program contrasting a preferred bone structure against the subject's present bone structure and using various algorithms to determine the appropriate three-dimensional image of the replacement implant. The preferred bone structure used for contrasting can be based on a computer generated model of the specific subject or previous images of the subject.

Another intended use for the implant may be for augmentation. Thus, the scanning device and software program may contrast a desired three-dimensional image or bone structure against the subject's current three-dimensional image or bone structure to determine the appropriate shape of the implant.

A further intended use for the implant may be for reducing bone structure. The implant may be used as a template or a stencil to guide the precise amount of bone to be removed from the subject's bone structure. The scanning device and software program may contrast a desired three-dimensional image or bone structure against the subject's current three-dimensional image or bone structure to determine the appropriate shape of the implant.

Once the preferred or desired shape of the implant is finalized by the DVT-scanning device and software program, the software is exported to a computer-aided design and manufacturing (CAD/CAM) milling machine 206.

Many types of computer-aided design and manufacturing software programs interfaced with numerically controlled machines are contemplated, in which the computer numerical controlled machines create the implants by carving or drilling or chiseling away or removing surplus material from the outside of a solid segment of material.

Furthermore, other types of manufacturing machines are contemplated. Such manufacturing machines include, but are not limited to, a machine that creates the shape through a molding process, a fabricating process, printing process, drilling or chiseling process, and any other process suitable for manufacturing a solid implant.

Next, the software program instructs the CAD/CAM milling machine 206 to use the digitized parameters of the shape 205 to create an implant 209 from an undefined segment of cadaver bone 207. Cadaver bone blocks may be gathered from tissue banks. A benefit of cadaver bone for the implant material is that it eliminates a secondary surgical site caused when harvesting bone from the own subject's body. The implant 209 is formed to be essentially consonant with the volume of the shape and suitable for implantation.

Ideally, the software supplies the CAD/CAM milling machine with the 3D CAD model determined from the scanning device and software program. The data can be converted into a STL file, a mesh of triangle that completely describes the exterior surface. Then, cutter paths can be generated straight from the STL file by the CAD/CAM milling machine.

The present disclosure provides a system for making an implant with the essentially desired architecture, structure, and volume. The disclosed combination of a scanning device, software program, and manufacturing machine enables the surgeon or practitioner to be able to directly place the implant into the subject without further manipulation other than infusing the bone with growth factors or other suitable media to decrease healing time. Additionally, the present disclosure allows for minimally invasive surgery as well as significantly reducing surgical time and attendant complications.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

I claim:

1. A system for manufacturing an implant, comprising:
a scanning device for determining a three-dimensional representation of a shape having a volume, said scanning device capable of digitizing parameters of said shape to define said shape; and
a software program for translating digitizing parameters into instructions for operating a manufacturing machine, through which said manufacturing machine creates said implant from an undefined segment of material.

2. The system of claim 1 wherein said implant is formed so that it is essentially consonant with the volume of said shape and wherein said implant is suitable for implantation.

3. The system of claim 1 wherein said implant is used for maxillofacial or dental reconstruction.

4. The system of claim 1 wherein said implant used for maxillofacial or dental augmentation.

5. The system of claim 1 wherein said implant used for maxillofacial or dental reduction of a body structure.

6. The system of claim 1 wherein said implant is used for a prosthesis for repairing or restoring at least a portion of at least one bone of a vertebrate.

7. The system of claim 1 wherein said scanning device uses digital volumetric tomography.

8. The system of claim 1 wherein said scanning device uses focused cone beam technology.

9. The system of claim 1 wherein said manufacturing machine is a CAD/CAM milling machine.

10. The system of claim 1 wherein said manufacturing machine creates the shape through a molding process.

11. The system of claim 1 wherein said material is bone from a donor or cadaver.

12. The system of claim 1 wherein said implant is used for repairing, restoring, or augmenting at least a portion of at least one bone of a vertebrate.

13. The bone of claim 12 wherein said vertebrate is selected from the group consisting of human, bovine, porcine, canine, feline or equine.

14. The vertebrate of claim 12 wherein said vertebrate is alive or deceased.

15. The system of claim 1 wherein said material is a material selected from the group consisting of plastic, polyethylene, hydroxyapatite, and synthetic bone compositions.

16. The system of claim 1 wherein said material is a material selected from the group consisting of a material with bone stimulating growth hormone, a material with growth factor, and a material that acts as a scaffolding and promotes bone growth within the material where the scaffolding will eventually break down and safely dissolve leaving the newly formed bone to continued to strengthen and become a full, natural replacement.

17. A system for manufacturing an implant, comprising:
a scanning device for determining a three-dimensional representation of a shape having a volume, wherein said scanning device uses digital volumetric tomography technology and said scanning device capable of digitizing parameters of said shape to define said shape; and
a software program for translating digitizing parameters into instructions for operating CAD/CAM milling machine through which said CAD/CAM milling machine creates said implant from an undefined segment of material.

18. The system of claim 17 wherein said implant is formed to be essentially consonant with the volume of said shape and wherein said implant is suitable for implantation.

19. The system of claim 17 wherein said material is donor bone or cadaver bone.

20. The system of claim 17 wherein said implant is used for repairing, restoring, or augmenting at least a portion of at least one bone of a vertebrate.

21. The bone of claim 20 wherein said vertebrate is selected from the group consisting of human, bovine, porcine, canine, feline or equine.

22. The vertebrate of claim 20 wherein said vertebrate is alive or deceased.

23. The system of claim 17 wherein said material is a material selected from the group consisting of plastic, polyethylene, hydroxy appetite, and synthetic bone compositions.

24. The system of claim 20 wherein said material is a material selected from the group consisting of a material with hormone stimulating growth hormone, a material with growth factor, and a material that acts as a scaffolding and promotes bone growth within the material where the scaffolding will eventually break down and safely dissolve leaving the newly formed bone to continued to strengthen and become a full, natural replacement.

25. The system of claim 17 wherein said implant is used for maxillofacial or dental reconstruction.

26. The system of claim 17 herein said implant is used for maxillofacial or dental augmentation.

27. The system of claim 17 wherein said implant is used for maxillofacial or dental reduction of a body structure.

28. An implant formed by:
scanning a subject with a scanning device in order to determine a three-dimensional representation of a shape and for digitizing parameters of the shape to define the shape;
interfacing the scanning device with a software program for translating digitizing parameters into instructions;
interfacing the software program and a manufacturing machine for instructing the machine; and
machining from an undefined segment of material an implant that is formed to be essentially consonant with the volume of the shape.

29. The implant of claim 29 wherein said material comprises donor bone.

30. An implant formed by:
scanning a subject with a scanning device using digital volumetric tomography in order to determine a three-dimensional representation of a shape and for digitizing parameters of the shape to define the shape;
interfacing the scanning device with a software program for translating digitizing parameters into instructions;
interfacing the software program and a CAD/CAM milling machine for instructing the CAD/CAM milling machine; and
machining from an undefined segment of cadaver bone an implant that is formed to be essentially consonant with the volume of the shape.

31. The implant of claim 30 wherein said material comprises donor bone.
